(19) United States
(12) Patent Application Publication
(10) Pub. No.: US 2021/0194280 A1
(43) Pub. Date: Jun. 24, 2021

(54) SMART POWER DEVICE

(71) Applicant: Chicony Power Technology Co., Ltd., New Taipei City (TW)

(72) Inventor: Chao-Cheng CHENG, New Taipei City (TW)

(21) Appl. No.: 16/829,293

(22) Filed: Mar. 25, 2020

(30) Foreign Application Priority Data
Dec. 24, 2019 (TW) 108147303

(51) Int. Cl. H02J 13/00; H01R 9/22; H01R 13/66

(52) U.S. Cl. CPC H02J 13/00022; H01R 9/226; H01R 13/6675; H01R 13/6691; H01R 9/223

(57) ABSTRACT

A smart power device includes a control module having a communication circuit and a switching circuit. A power transfer unit is electrically connected to the switching circuit. A main shell seat has a first receiving slot, a second receiving slot and an insertion portion. A first conductive sheet is disposed in the first receiving slot. A second conductive sheet is disposed in the second receiving slot. A separation shell seat has a separation receiving slot and a sliding rail, and the separation shell seat is coupled to the main shell seat through the sliding rail inserting in the insertion portion, and a separation conductive sheet is disposed in the separation receiving slot.

### BACKGROUND OF THE INVENTION

### Field of the Invention

The present invention generally relates to a power device and, in particular to a smart power device.

### Description of Prior Art

An electric appliance is usually in standby mode without powering off automatically when not in use. However, electrical appliances will still cause power loss even if they are not running; thus, it does not satisfy the environmental protection requirements of energy conservation and carbon reduction.

Moreover, with the popularity of cloud computing platforms, power management and power control also keep up with the times. Therefore, power products need to be adjusted internally in response to system instructions, such as shutdown, startup, or status reporting, etc. to meet requirements of the cloud computing. In addition, the appearance of today's products requires miniaturization. In this regard, how to provide a miniature smart power device is the research motivation of the inventor.

In view of the above drawbacks, the inventor proposes the present invention based on his expert knowledge and elaborate researches in order to solve the problems of prior art.

### SUMMARY OF THE INVENTION

Accordingly, an object of the present invention is to provide a smart power device to simplify the assembly and improve the yield rate of production.

Accordingly, an object of the present invention is to provide a smart power device having advantages of small volume, low cost, and high security.

In order to achieve the objects mentioned above, the present invention provides a smart power device including a control module and a power transfer unit. The control module includes a circuit board, a communication circuit, a control circuit and a switching circuit, wherein the communication circuit, the control circuit and the switching circuit are disposed on the circuit board. The communication circuit is capable of receiving a wireless signal for generating a command signal. The control circuit generates a control signal according to the command signal. The switching circuit has a first cable and a second cable and is capable of conducting or interrupting the first cable and the second cable according to the control signal. The power transfer unit is electrically connected with the switching circuit for receiving an AC input voltage and will supply an output voltage according to the control signal. The power transfer unit comprises a main shell seat, a first conductive sheet, a second conductive sheet, a separation shell seat and a separation conductive sheet. The main shell seat has a first receiving slot, a second receiving slot and an insertion portion. The first conductive sheet is disposed in the first receiving slot. The first conductive sheet has one end used to receive the AC input voltage and the other end used to supply the output voltage. The second conductive sheet is disposed in the second receiving slot. The second conductive sheet has one end used to receive the AC input voltage and the other end used to electrically connect with the first cable. The separation shell seat has a separation receiving slot and a sliding rail. The separation shell seat inserts into the insertion portion through the sliding rail to combine with the main shell seat. The separation conductive sheet is disposed in the separation receiving slot. The separation conductive sheet has one end electrically connected with the second cable and the other end used to supply the output voltage, wherein the control circuit conducts or interrupts the first cable and the second cable through the switching circuit to provide or interrupt the output voltage.

Comparing to the prior art, the smart power device of the present invention includes a power transfer unit that has the power input and power output disposed in corresponding front and rear sides, so that the overall volume can be reduced. Furthermore, the separation conductive sheet and the second conductive sheet of the present invention are individually arranged in their respective slots and are isolated from each other so as to achieve the purpose of electrical insulation. In addition, the separation conductive sheet of the present invention is disposed in the separation shell seat, and then the separation shell seat will slide into the main shell seat. Thereby, the purpose of electrical connection in a limited space will be achieved, and the assembly of the power transfer unit will be simplified. Furthermore, when the power transfer unit is plugged or unplugged, each of the conductive sheets can be held in a good electrical conduction under an external force. Therefore, the safety and practicability of the present invention will be enhanced.

### BRIEF DESCRIPTION OF DRAWINGS

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 and FIG. 2 are perspective appearance views in two sides of the smart power device of the present invention.

FIG. 3 is a perspective explosion view of smart power device of the present invention.

FIG. 4 is a perspective appearance view of the power transfer unit of the present invention.

FIG. 5 is a partial perspective explosion view of the power transfer unit of the present invention.

FIG. 6 is a perspective explosion view of the conductive sheet and the main shell seat of the present invention.

FIG. 7 is a perspective explosion view of the separation shell seat and the separation conductive sheet of the present invention.

FIG. 8 is another embodiment of the separation shell seat of the present invention.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

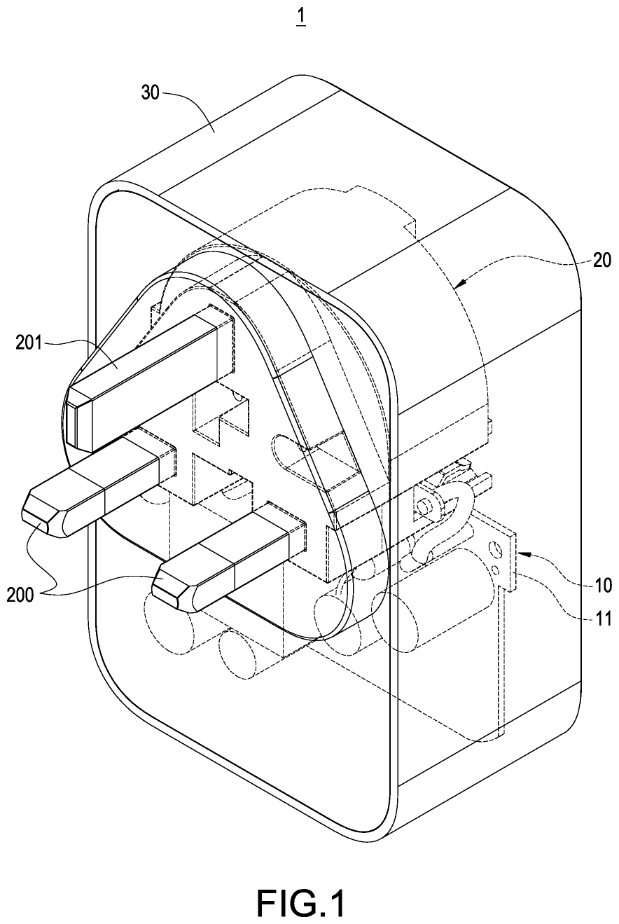

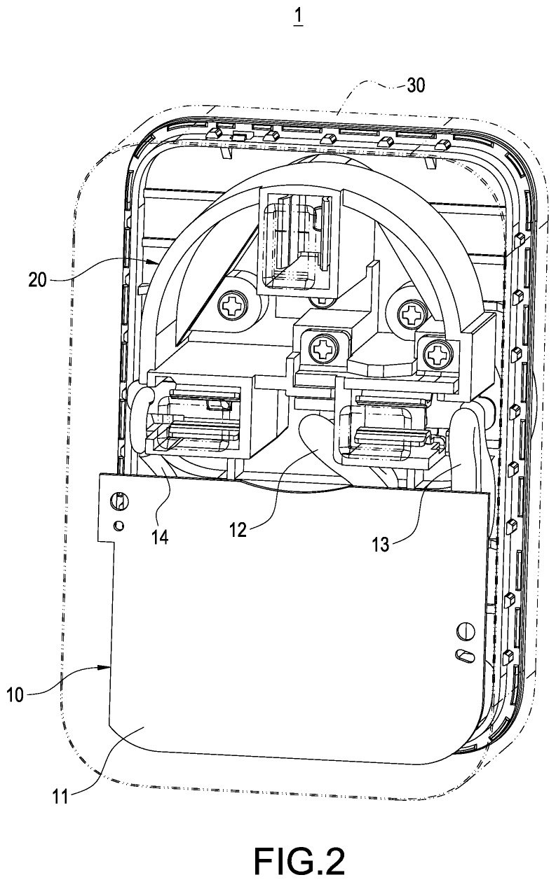

Please refer to FIG. 1 and FIG. 2, which depict perspective appearance views in two sides of the smart power device of the present invention. The present invention is a smart power device 1 including a control module 10 and a power transfer unit 20. The control module 10 is electrically connected with the power transfer unit 20 for controlling the operation of the power transfer unit 20. Preferably, the smart power device 1 further includes a housing seat 30. The control module 10 and the power transfer unit 20 are disposed in the housing seat 30 to constitute the smart power device 1.

In one embodiment of the present invention, the control module 10 includes a circuit board 11, a communication circuit, a control circuit and a switching circuit (not numbered), wherein the communication circuit, the control circuit and the switching circuit are disposed on the circuit board 11. The communication circuit is capable of receiving a wireless signal for generating a command signal. The control circuit generates a control signal according to the command signal.

The switching circuit has a first cable 12, a second cable 13 and a third cablel4, and the switching circuit is capable of conducting or interrupting the first cable 12 and the second cable 13 according to the control signal to provide or interrupt the output voltage.

Moreover, the power transfer unit 20 is electrically connected with the switching circuit for receiving an AC input voltage and providing an output voltage according to the control signal. In addition, the power transfer unit 20 further includes a plurality of power pins 200 and a grounding pin 201 for receiving the AC input voltage. The structures of the power transfer unit 20 will be described in more detail later.

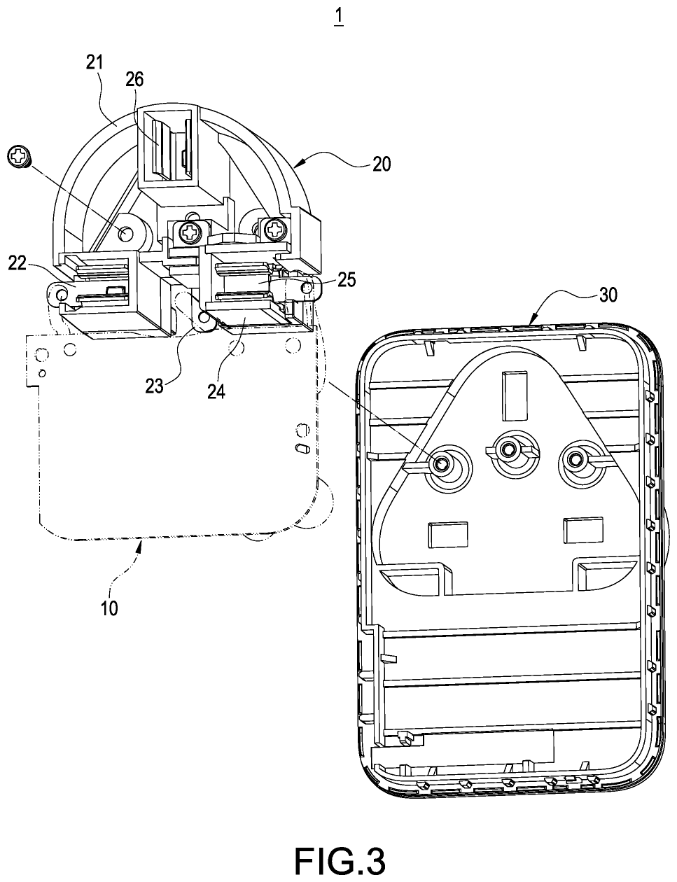

With referring to FIG. 3, it depicts a perspective explosion view of smart power device of the present invention. The control module 10 and the power transfer unit 20 are fixed in the housing seat 30. The power transfer unit 20 includes a main shell seat 21, a first conductive sheet 22, a second conductive sheet 23, a separation shell seat 24, a separation conductive sheet 25 and a grounding conductive sheet 26. The first conductive sheet 22, the second conductive sheet 23 and the grounding conductive sheet 26 are assembled in the main shell seat 21. In addition, the separation conductive sheet 25 is assembled in the separation shell seat 24 and then combined to the main shell seat 21.

It is worthy to note that, the power pins 200 in the FIG. 1 are disposed on a side of the main shell seat 21 away from the separation shell seat 24 and are electrically connected with the first conductive sheet 22 and the second conductive sheet 23 separately. Another thing is worthy to note that, the power pins 200 and the grounding pin 201 are located at a front side of the main shell seat 21. The first conductive sheet 22, the second conductive sheet 23 and the grounding conductive sheet 26 are disposed at a rear side of the main shell seat 21 corresponding to the positions of the power pins 200 and the grounding pin 201. Thereby, the positions of the aforementioned conductive members will be disposed at the corresponding front and rear sides of the main shell seat 21; thus, the purpose of reducing the overall volume will be achieved.

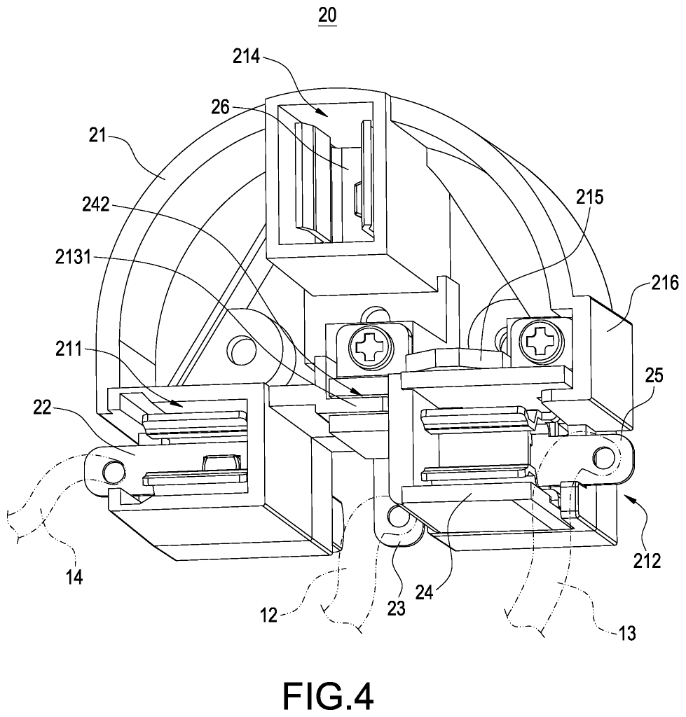

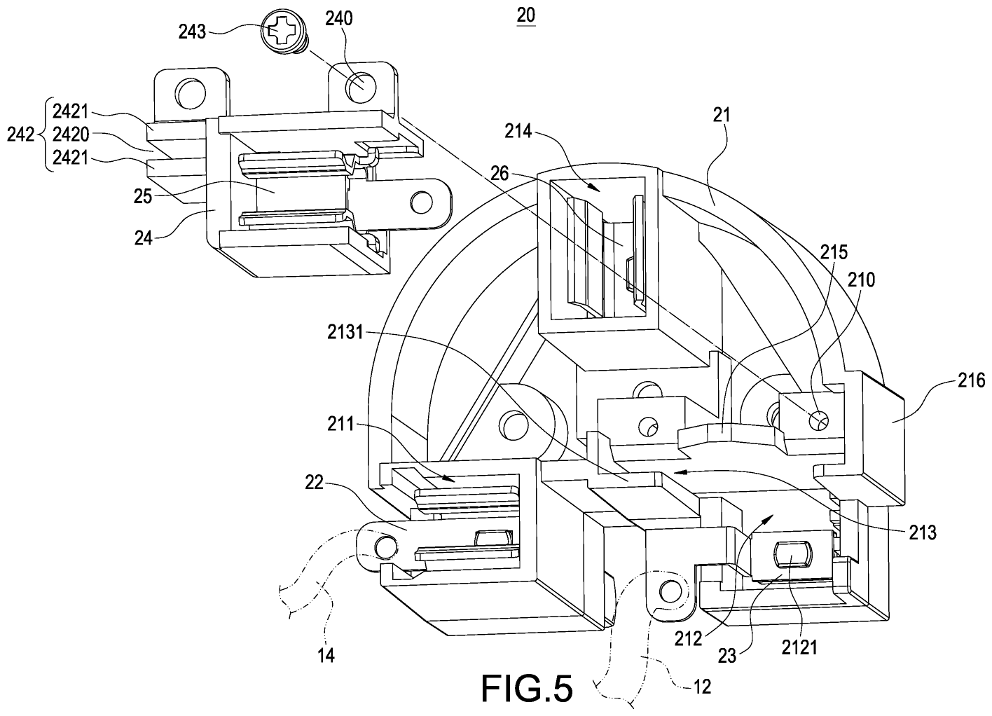

Please further refer to FIG. 4 to FIG. 7, which depict a perspective appearance view of the power transfer unit of the present invention, a partial perspective explosion view of the power transfer unit of the present invention, a perspective explosion view of the conductive sheet and the main shell seat, and a perspective explosion view of the separation shell seat and the separation conductive sheet of the present invention. Please refer to FIG. 4 and FIG. 5. The main shell seat 21 has a first receiving slot 211, a second receiving slot 212, an insertion portion 213 and a grounding slot 214. The first conductive sheet 22 is disposed in the first receiving slot 211, wherein an end of the first conductive sheet 22 is used to receive the AC input voltage (coupled to the power pins 200 in FIG. 1) and another end of the first conductive sheet 22 is connected to the third cable 14 for providing the output voltage. The second conductive sheet 23 is disposed in the second receiving slot 212, wherein an end of the second conductive sheet 23 is used to receive the AC input voltage (coupled to the power pins 200 in FIG. 1) and another end of the second conductive sheet 23 is used to electrically connect with the first cable 12. In addition, the separation conductive sheet 25 is disposed in the separation shell seat 24, wherein an end of the separation conductive sheet 25 is electrically connected with the second cable 13 and another end of the separation conductive sheet 25 is used to provide the output voltage. The grounding conductive sheet 26 is disposed in the grounding slot 214, wherein an end of the grounding conductive sheet 26 is used for coupling with the grounding pin 201 in FIG. 1 and another end of the grounding conductive sheet 26 is provided for ground coupling.

In an embodiment of the present invention, the first conductive sheet 22, the second conductive sheet 23, the separation conductive sheet 25 and the grounding conductive sheet 26 are U-shaped conductive sheets separately. Moreover, the first receiving slot 211, the second receiving slot 212, the separation shell seat 24 and the grounding slot 214 are open slots separately for increasing creepage distances by recessed structures. Therefore, the safety of the invention will be enhanced while using.

Specifically, the insertion portion 213 is located at a side of the second receiving slot 212. The main shell seat 21 has formed with a positioning block 2121 at the second receiving slot 212. The second conductive sheet 23 is positioned and fixed by the positioning block 2121, and an insertion piece 2131 is provided at one side of the insertion portion 213. In addition, the sliding rail 242 is composed of two protrusion pieces 2421 arranged at intervals, and a through slot 2420 is formed between the two protrusion pieces 2421. When the separation shell seat 24 is assembled to the main shell seat 21, the separation shell seat 24 is inserted from top of the insertion portion 213 downwardly, and then the insertion piece 2131 is inserted in the through slot 2420 of the sliding rail 242 of the separation shell seat 24. At last, the separation shell seat 24 will be positioned on top of the second receiving slot 212. That is, the separation conductive sheet 25 and the second conductive sheet 23 are individually disposed in different slots and the separation conductive sheet 25 will be stacked upon the second conductive sheet 23. Therefore, the purpose of reducing the overall size will be achieved. Further, the main shell seat 21 is formed with a screw hole 210 at one side of the insertion portion 213. In addition, the separation shell seat 24 is formed with a perforation 240 at a side facing the insertion portion 213, and the separation shell seat 24 is fixed on the main shell seat 21 by a screw 243 inserting the perforation 240 and the screw hole 210.

It is worthy to note that, in the present embodiment, the separation shell seat 24 is inserted into the second receiving slot 212 to be fixed through the insertion piece 2131 from top of the main shell seat 21 in a vertical (longitudinal) direction. However, the direction of insertion is not limited in real practice, the separation shell seat 24 can be inserted into the top of the second receiving slot 212 through the insertion piece 2131 in a horizontal (lateral) direction of the main shell seat 21.

It is worth of noticing that the main shell seat 21 is formed with a blocking plate 215 and a stopper 216 around the insertion portion 213. When the separation shell seat 24 is inserted in the insertion portion 213, the separation shell seat 24 is supported by the insertion piece 2131, the blocking plate 215 and the stopper 216 simultaneously. Therefore, when the smart power device 1 is plugged or unplugged under an external force, the separation shell seat 24 will not be moved to prevent from unstable electrical connections.

Accordingly, the control module 10 conducts or interrupts the first cable 12 and the second cable 13 through the switching circuit for providing or interrupting the output voltage.

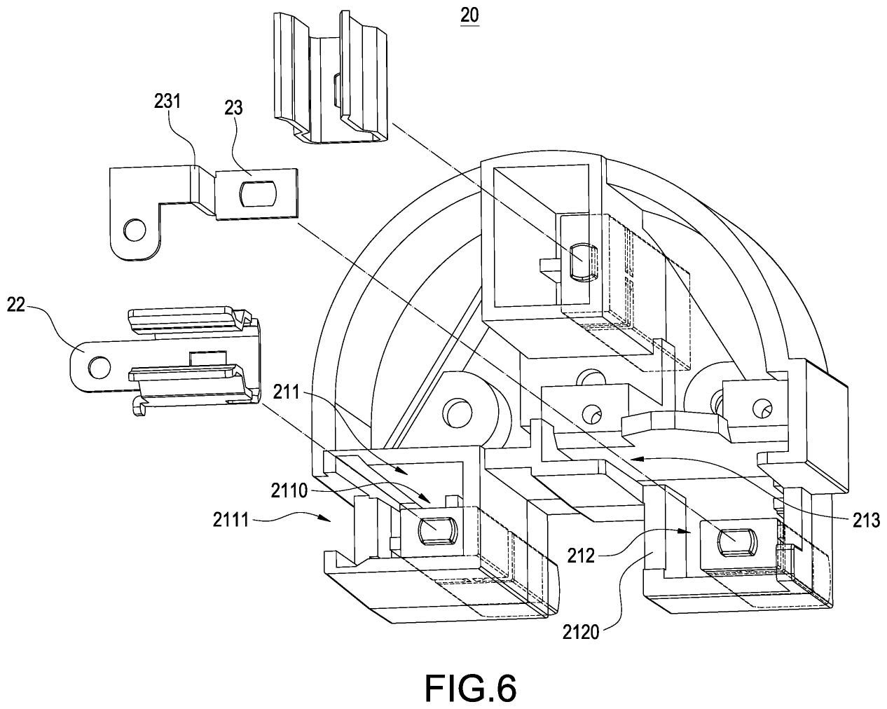

Please refer to FIG. 6, in an embodiment of the present invention, in the structure of the power transfer unit 20, the first receiving slot 211 has a first opening 2110 and a first notch 2111. The first notch 2111 is located at a side away from the insertion portion 213 and communicated with the first opening 2110. The first conductive sheet 22 is placed into the first receiving slot 211 from the first opening 2110.

Furthermore, the second receiving slot 212 has a stepped opening 2120, and the stepped opening 2120 is located at a side neighboring the first receiving slot 211. The second conductive sheet 23 is an L-shaped conductive sheet and has a bent section 231, and the bent section 231 protrudes from the stepped opening 2120 to connect the first cable 12 (see FIG. 5).

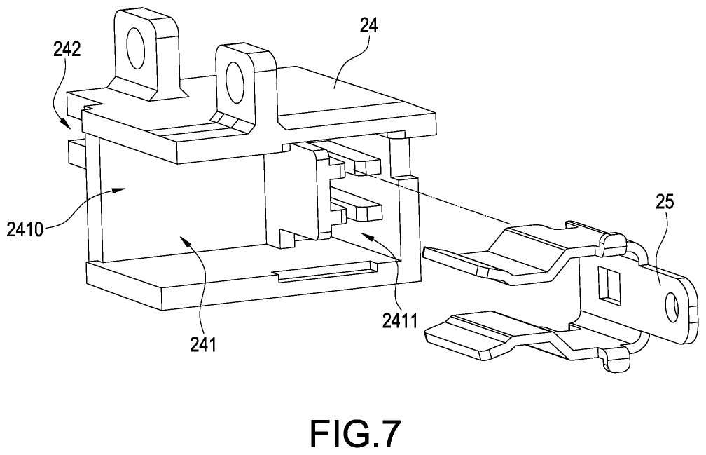

As shown in FIG. 7, the separation shell seat 24 has a separation receiving slot 241 and a sliding rail 242, and the separation conductive sheet 25 is combined in the separation receiving slot 241. The separation shell seat 24 is inserted into the insertion portion 213 through the sliding rail 242 to combine with the main shell seat 21 (see FIG. 5).

Specifically, the separation receiving slot 241 has a separation opening 2410 and a separation slot 2411. The separation opening 2410 is located at a side away from the second receiving slot 212, and the separation slot 2411 is located at a side away from the first receiving sot 211 and communicated with the separation opening 2410. In the present embodiment, the separation conductive sheet 25 is inserted from the separation slot 2411 and combined in the separation receiving slot 241.

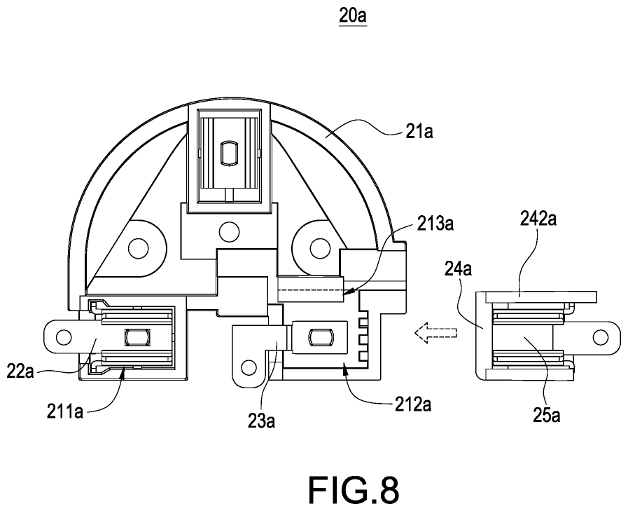

Please further refer to FIG. 8, which depicts another embodiment of the separation shell seat of the present invention. The present embodiment is substantially the same as the previous embodiment. A power transfer unit 20a includes a main shell seat 21a, a first conductive sheet 22a, a second conductive sheet 23a, a separation shell seat 24a and a separation conductive sheet 25a. The first conductive sheet 22a and the second conductive sheet 23a are assembled in the main shell seat 21a. In addition, the separation conductive sheet 25a is assembled in the separation shell seat 24a and then combined with the main shell seat 21a.

Moreover, the main shell seat 21a has a first receiving slot 211a, a second receiving slot 212a and an insertion portion 213a. In the present embodiment, the insertion portion 213a is extended in a direction of away from the first receiving slot 211a toward the first receiving slot 211a. On the other hand, the separation shell seat 24a has a sliding rail 242a.

While assembling, the sliding rail 242a of the separation shell seat 24a slides into the insertion portion 213a from a side of the main shell seat 21a toward the first receiving slot 211a, so that the insertion portion 213a will insert into the sliding rail 242a for combining the separation shell seat 24a to the main shell seat 21a. That is, the separation shell seat 24a is inserted and positioned in the insertion portion 213a in a horizontal direction (lateral direction) of the main shell seat 21a by a drawer type coupling manner. Therefore, the disposition of screws and screw holes in the foregoing embodiments can be omitted, and the assembly structure can be simplified.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A smart power device, comprising:
a control module including a circuit board, a communication circuit, a control circuit, and a switching circuit, wherein the communication circuit, the control circuit and the switching circuit are disposed on the circuit board; the communication circuit being capable of receiving a wireless signal for generating a command signal; the control circuit generating a control signal according to the command signal; and the switching circuit having a first cable and a second cable and being capable of conducting or interrupting the first cable and the second cable according to the control signal; and
a power transfer unit electrically connected with the switching circuit for receiving an AC input voltage and supplying an output voltage according to the control signal, comprising:
a main shell seat having a first receiving slot, a second receiving slot and an insertion portion;
a first conductive sheet disposed in the first receiving slot, wherein an end of the first conductive sheet is used to receive the AC input voltage and another end of the first conductive sheet is used to supply the output voltage;
a second conductive sheet disposed in the second receiving slot, wherein an end of the second conductive sheet is used to receive the AC input voltage and another end of the second conductive sheet is used to electrically connect with the first cable;
a separation shell seat having a separation receiving slot and a sliding rail, and the separation shell seat inserting into the insertion portion through the sliding rail to combine with the main shell seat; and
a separation conductive sheet disposed in the separation receiving slot, wherein an end of the separation conductive sheet is electrically connected with the second cable and another end of the separation conductive sheet is used to supply the output voltage;
wherein the control circuit conducts or interrupts the first cable and the second cable through the switching circuit to provide or interrupt the output voltage.

2. The smart power device according to claim 1, wherein the first receiving slot has a first opening and a first notch, and the first opening is located at a side away from the insertion portion and communicated with the first opening.

3. The smart power device according to claim 2, wherein the second receiving slot has a stepped opening; the stepped opening is located at a side neighboring the first receiving slot; and
the second conductive sheet is an L-shaped conductive sheet and has a bent section, and the bent section protrudes from the stepped opening to connect the first cable.

4. The smart power device according to claim 3, wherein the separation receiving slot has a separation opening and a separation slot; the separation opening is located at a side away from the second receiving slot; and the separation slot is located at a side away from the first receiving sot and communicated with the separation opening.

5. The smart power device according to claim 1, wherein the insertion portion is located at a side of the second receiving slot; the main shell seat has formed with a positioning block at the second receiving slot; and the separation shell seat is positioned on top of the second receiving slot when the sliding rail of the separation shell seat is inserted in the insertion portion.

6. The smart power device according to claim 4, wherein an insertion piece is provided at one side of the insertion portion; the sliding rail is composed of two protrusion pieces arranged at intervals, and a through slot is formed between the two protrusion pieces; and the insertion piece is inserted in the through slot.

7. The smart power device according to claim 1, wherein the main shell seat is formed with a screw hole at one side of the insertion portion; the separation shell seat is formed with a perforation on a side facing the insertion portion; and the separation shell seat is fixed on the main shell seat by a screw inserting the perforation and the screw hole.

8. The smart power device according to claim 1, wherein the insertion portion extends in a direction of away from the first receiving slot toward the first receiving slot, and the sliding rail slides into the insertion portion in a direction of from a side of the main shell seat toward the first receiving slot.

9. The smart power device according to claim 1, wherein the power transfer unit further includes a plurality of power pins for receiving the AC input voltage, and the power pins are disposed on the main shell seat at a side of away from the separation shell seat and are electrically connected with the first conductive sheet and the second conductive sheet separately.

10. The smart power device according to claim 9, wherein the main shell seat further includes a grounding slot; the power transfer unit further includes a grounding conductive sheet;
the grounding conductive sheet has one end for coupling with a grounding pin and another end provided for ground coupling; and the grounding conductive sheet is disposed in the grounding slot.
